(19) United States
(12) Patent Application Publication
(10) Pub. No.: US 2023/0163634 A1
(43) Pub. Date: May 25, 2023

(54) AUTOMOTIVE CENTER CONSOLE WIRELESS CHARGING SYSTEM

(71) Applicant: Yank Technologies, Inc., Brooklyn, NY (US)

(72) Inventor: Joshua Aaron YANKOWITZ, Brooklyn, NY (US)

(73) Assignee: Yank Technologies, Inc., Brooklyn, NY (US)

(21) Appl. No.: 17/905,474

(22) PCT Filed: Mar. 5, 2021
(86) PCT No.: PCT/US2021/021106

§ 371 Date: Sep. 1, 2022

Related U.S. Application Data
(60) Provisional application No. 62/986,491, filed on Mar. 6, 2020.

(51) Int. Cl. H02J 50/12; H02J 50/00; H01Q 1/22; B60R 7/04; H01Q 1/36

(52) U.S. Cl. CPC H02J 50/12; B60R 7/04; H01Q 1/22; H01Q 1/36; H02J 50/005; B60R 2011/0007

(57) ABSTRACT

A wireless charging system integrated into a vehicle console includes an antenna having a continuous conductor with no breaks or radio frequency discontinuities, and a thickness that is approximately equal to 10 um or greater. The antenna is disposed within or partially within one or more contours of the vehicle console. The wireless charging system also includes an amplifier configured to drive a signal to the antenna, and one or more capacitors configured to excite the antenna into resonance.

### RELATED APPLICATIONS

This application claims priority to and benefit from U.S. Provisional Pat. Application No. 62/986,491, entitled “AUTOMOTIVE CENTER CONSOLE WIRELESS CHARGING SYSTEM,” filed on Mar. 6, 2020, which is hereby incorporated by reference in its entirety.

### BACKGROUND

With the proliferation of car sharing services, there is a need to incorporate efficient wireless charging systems that can fit in, for example, the center console of automotive vehicles.

### BRIEF SUMMARY

Various designs of wireless charging systems are described. The designs may be incorporated into vehicle consoles.

In one example aspect, the disclosed technology provides a system and method for fabricating or retrofitting a wireless charging system into a vehicle console where the wireless charging system is configured to wirelessly charge multiple electronic devices located near the console (e.g., in cupholders or package tray areas) simultaneously and to provide additional freedom and flexibility in the placement, orientation and positioning of the electronic devices relative to the console.

In another example aspect, a wireless charging system is described. The system can be integrated in a vehicle console and includes an antenna comprising a continuous conductor with no breaks or radio frequency discontinuities. The continuous conductor has a thickness that is approximately equal to 10 um (micrometer) or greater, and the antenna is disposed within or partially within one or more contours of the vehicle console. The system also includes an amplifier configured to drive a signal to the antenna, and one or more capacitors configured to excite the antenna into resonance.

In another example aspect, a method for fabricating a wireless charging system is described. The wireless charging system can be embedded in a vehicle console (e.g., a vehicle center console). The method includes attaching an amplifier printed circuit board (PCB) to a first area of an electrically non-conductive support structure of the vehicle console; attaching a filter PCB to a second area of the support structure, wherein the filter PCB is electrically coupled to the amplifier PCB and is configured to receive an amplified signal from the amplifier PCB; and, attaching a resonant capacitor PCB to a third area of the support structure. The resonant capacitor PCB is electrically coupled to the filter PCB and to one or more antennas and is configured to receive a filtered signal from the filter PCB and drive the filtered signal onto the one or more antennas. The first area, the second area, and the third area of the support structure are selected to maintain a physical separation between the amplifier PCB, the resonant capacitor PCB, the filter PCB, and the one or more antennas, and a distance of the physical separation between the filter PCB and the amplifier PCB, and a distance of the physical separation between the filter PCB and the resonant capacitor PCB is at least 10 mm.

These, and other, aspects are disclosed throughout the document.

### BRIEF DESCRIPTION OF THE DRAWINGS

FIG. 1A is a first view of a representative three-dimensional antenna inside a vehicle center console.

FIG. 1B is a second view of a representative three-dimensional antenna inside a vehicle center console.

FIG. 2 is a representative illustration of an internal view of a vehicle center console with an embedded wireless charging system.

FIG. 3A is a representative view of a fully assembled vehicle center console with an embedded wireless charging system.

FIG. 3B is a representative view of the fully assembled vehicle center console of FIG. 3A showing additional detail.

FIG. 4 is a representative illustration showing a vehicle center console wireless charging system simultaneously charging multiple electronic devices.

FIG. 5 is a representative illustration showing a vehicle center console wireless charging system charging a handheld electronic device.

### DETAILED DESCRIPTION

The disclosed technology provides a system and method for retrofitting a wireless charging system into a vehicle center console where the wireless charging system can wirelessly charge multiple electronic devices located near the center console (e.g., in cupholders). The wireless charging system can charge multiple electronic devices simultaneously in multiple orientations and positions relative to the center console. The disclosed technology can be used by vehicle original equipment manufacturers (OEMs) looking to incorporate efficient wireless charging systems for vehicle consoles or vehicle center consoles (e.g., private passenger motor vehicles, commercial motor vehicles, airplanes, trains, boats and other watercraft, and other modes of transport or locomotion such as motorcycles, bicycles, wagons, agricultural equipment such as tractors, industrial equipment such as forklifts, etc.). The vehicle console can be any panel or unit in the vehicle accommodating the disclosed technology including, but not limited to, the support between the seats of the vehicle that have indentations for holding items.

Various embodiments will now be described. The following description provides specific details for a thorough understanding and an enabling description of these embodiments. One skilled in the art will understand, however, that embodiments can be practiced without many of these details. Additionally, some well-known structures or functions may not be shown or described in detail, to avoid unnecessarily obscuring the relevant description of the various embodiments. The terminology used in the description presented below is intended to be interpreted in its broadest reasonable manner, even though it is being used in conjunction with a detailed description of certain specific embodiments.

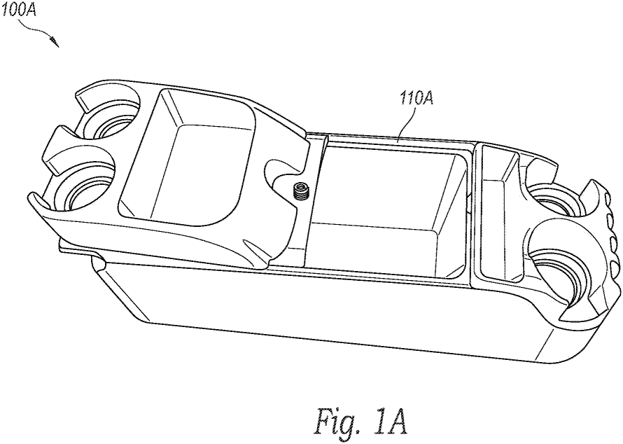

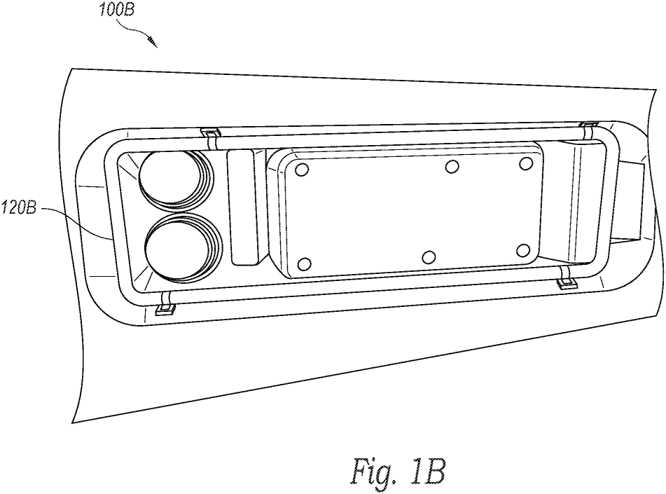

FIG. 1A is a first view 100A of a representative three-dimensional antenna inside a vehicle center console. In one embodiment a three-dimensional antenna can be retrofitted into the outline 110A of the vehicle center console by having the length, width, and height of the antenna embedded into the contours (or at least partially embedded into the contours) of the center console’s parts (e.g., in a passenger vehicle center console). That is, the three-dimensional antenna is adapted to fit within the contours of a target device while optimizing the antenna’s magnetic flux within the target device (e.g., optimizing the magnetic flux in the cupholder region of a vehicle center console).

In one embodiment, the three-dimensional antenna can be a surface spiral coil made up of a continuous conductor with no breaks or radio frequency discontinuities. The conductor can be wound around a dielectric material at an angle to diminish the proximity effect at an operational frequency of the wireless charging transmitter device, and to maintain a high intrinsic quality factor (“Q”) of the surface spiral coil at the operating frequency. The continuous conductor can have a thickness approximately of 10 um (micrometer) or greater (e.g., 40 um). U.S. Patent Application Number 15/759,473 (U.S. Publication 2018/0262050), incorporated by reference herein in entirety, describes an example embodiment of three-dimensional antennas which may be used with the disclosed technology. For example, the Q factor may be higher than 200, or higher than 400 or around 700 or higher. One example working range may include surface spiral coils having 700 to 800 Q factor.

The disclosed technology provides an efficient and convenient means of charging passenger devices near the center console unit in a vehicle. The wireless charging transmitter is connected to the vehicle’s power supply and consists of an amplifier that drives the three-dimensional antenna inside the center console unit (or drives one or more antennas inside the center console in the case of multiple antennas). The wireless charging system also includes one or more capacitors configured to excite the three-dimensional antenna(s) into resonance, where the driven signal is at an operating frequency that is approximately equal to the resonant frequency of the three-dimensional antenna(s). That is, in some embodiments, the wireless charging system includes an amplifier (e.g., in an amplifier PCB) that drives a signal to one or more filters (e.g., in filter PCBs) and the filtered output is coupled to resonant capacitors (e.g., in resonant capacitor PCBs). The resonant capacitors are coupled to the antennas as described above. In some embodiments, one or more of the amplifier, the filters, the resonant capacitors, or the antennas are mutually physically separated from each other (e.g., by 1 inch or more) to minimize or decrease a cross-coupling loss, switching loss, hysteresis loss, among other losses.

In some embodiments, the wireless charging system embedded in the vehicle center console is fabricated to utilize an isolated switching amplifier system topology where the wireless charging amplifier system components are sufficiently isolated to improve overall system performance. For example, the amplifier in an amplifier printed circuit board (PCB) is attached to a first area of an electrically non-conductive support structure of the vehicle center console. The filter in the filter PCB is attached to a second area of the support structure, where the filter in the filter PCB is electrically coupled to the amplifier in the amplifier PCB. The filter receives an amplified signal from the amplifier. There may be more than one filter in a differential configuration. One or more capacitors in a resonant capacitor PCB is attached to a third area of the support structure. The resonant capacitors in the resonant capacitor PCB is electrically coupled to the filter(s) and to one or more antennas. The resonant capacitors receive a filtered signal from the filter(s) and drive the filtered signal(s) to one or more antennas. To improve performance (e.g., reduce coupling losses, hysteresis losses, switching losses, etc.), the first area, the second area, and the third area of the support structure are selected to maintain a physical separation (e.g., 10 mm or more) between the amplifier PCB, the resonant capacitor PCB, the filter PCBs, and the one or more antennas. The antennas can be three-dimensional antennas as described above, planar antenna, or electrodeposited antennas where the antenna conductor is electrodeposited directly onto the support structure or other mechanical part of the vehicle center console. Furthermore, the resonant capacitor PCB can be placed in a separate second structure while the amplifier PCB and filter PCB(s) are placed in a first structure in order to reduce the distance between the resonant capacitor PCB and the antennas and thereby reduce the resistance between the antenna and its resonant capacitors. Maintaining the physical separation as described above minimizes or decreases cross-coupling losses, switching losses, hysteresis losses, etc., thereby improving the overall performance of the wireless charging system. In some embodiments, the components of the isolated switching amplifier system are contained in a modular structure or structures that are embedded into the vehicle center console rather than the components being attached to a support structure of the vehicle console.

The center console antenna is reshaped towards either the outline of the center console or the outline of a section of the center console, such as a specific mold location in the center console to meet, for example, the packaging requirements of an original equipment manufacturer (OEM). A single device or multiple devices in the vicinity of, or proximate to, the vehicle center console can be simultaneously charged by the vehicle center console regardless of orientation of the device or devices. That is, the devices can be at various distances and at different angles with respect to the center console and still be reliably charged by the wireless charging system integrated in the center console. For example, the devices can be in the cupholder or held by the passenger, etc. In some embodiments, the wireless charging system can provide 10 Watts or more of power to devices located in the cupholder and 5 Watts or more of power to devices located approximately 8 inches or more away from charging system embedded in the vehicle center console.

The transmitter emits a safe magnetic field that can be captured by a receiver device or multiple receiver devices (e.g., one or more smartphones). These receiver devices can be placed in various locations around the center console, such as the cupholders or on top of the center console unit. This provides a greater degree of freedom for the passenger(s) to wireless charge their devices, and allows charging multiple devices at the same time.

The disclosed technology provides greater freedom for the placement of passenger devices, and the ability to charge multiple passenger devices simultaneously. This contrasts prior art charging pads which are typically sensitive to the alignment or orientation of the electronic devices (e.g., smartphones) on the charging pad. That is, the disclosed technology (e.g., the three-dimensional antenna and corresponding amplifier and other electronics) is designed to reduce a sensitivity of the wireless charging system to a change of orientation of a wireless device relative to the vehicle center console, i.e., provide the electronic devices being charged better freedom of movement while charging. For example, the smartphone’s position or orientation on the charging pad can be affected as the vehicle turns which can affect the rate of charging of the device (or in some cases prevent the smartphone from charging at all). Furthermore, it can be difficult to charge multiple devices simultaneously in prior art systems due to space limitations of the charging pad. The space constraints arise because the charging pads typically require near physical contact with the receiver (e.g., smartphone) for effective operation.

In one embodiment, an aftermarket vehicle product includes the three-dimension antenna placed inside the center console, such as an open compartment, rather than being directly retrofitted to the contours of the center console (i.e., disposed within or at least partially within the center console contours of the center console vehicle part). In this embodiment, the transmitter can connect to a separate rechargeable battery, or can connect to the vehicle’s battery as its supply via an available charging port in the vehicle.

In one embodiment, the three-dimensional antenna can be replaced by a planar antenna or an electrodeposition process can be used to build the antenna directly onto an inner part in the center console unit due to size constraints for production. In this embodiment, the transmitter consists of the antenna and the amplifier unit connected to the supply line in the vehicle. Furthermore, in this embodiment, the transmitter may also consist of filters for harmonic reduction and a DC supply PCB or separate board that applies the necessary voltages for the amplifier, such as the logic, amplifier, and fan voltages.

In one embodiment, the transmitter can include a switching parallel or series resonant or off-resonant power amplifier (e.g., a Class D or E amplifier) that is either single-ended or differentially coupled to the antenna (e.g., the amplifier in the amplifier PCB can be differentially coupled to two filters in one or two filter PCBs, and also differentially coupled to the resonant capacitors in the resonant capacitor PCB(s)). In a parallel-tuned power amplifier, the load network and matching network are tuned such that the transmitter antenna is in parallel rather than in series to the resonant capacitor with the load network of the amplifier also tuned at the same resonant frequency. That is, the entire power amplifier network operates completely in resonance rather than using an off-resonant load network. This way, the voltage across the transmitter is maximized and harmonics are reduced. By maximizing the voltage, there is higher oscillating current flowing through the transmitter antenna or a stronger magnetic field to be coupled with the receiver, especially in a loose coupling resonant inductive system, such as when the transmitter and receiver are physically far apart. In some embodiments, a transformer can also be included to further increase the oscillating voltage across the transmitter antenna and thereby further improve the flux linkage and power delivery between the transmitter and receiver. Additionally, the parallel resonant power amplifier is better protected from movements or changes in the position of the receiver or capacitive and inductive reflections from the surrounding environment that could cause a substantial change in the efficiency of the power amplifier.

In another embodiment, the transmitter system can be configured with isolated subsystems to lower thermal stress on switching components thereby resulting in better operational stability and improved performance.

FIG. 1B is a second view 100B of a representative three-dimensional antenna inside a vehicle center console (showing a bottom view of the vehicle center console of FIG. 1A). The second view 100B shows a three-dimensional antenna 120B made up of one or more three dimensional coils (only one coil is depicted in FIG. 1B).

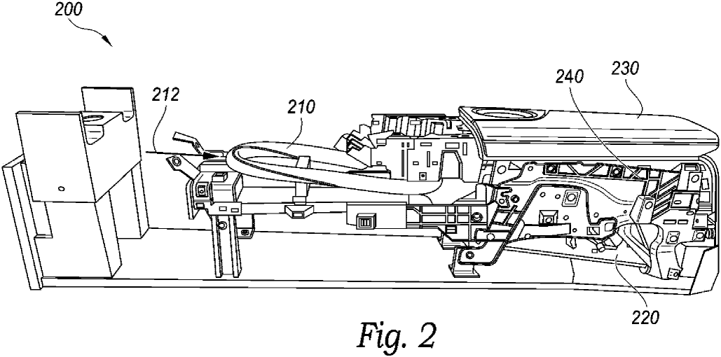

FIG. 2 is a representative illustration of an internal view 200 of a vehicle center console with an embedded wireless charging system. The internal view 200 shows antenna 210 occupying a certain portion of the center console rather than outline the entire automotive center console as in FIG. 1B. Antenna 210 can be a three-dimensional antenna as described in relation to FIG. 1A. Arrow 212 points to an example orientation of antenna 210 selected to focus the antenna’s magnetic field to the center console’s cupholders which vehicle occupants’ often use to hold electronic devices (e.g., mobile phones) to be charged by the wireless charging system. In other embodiments, the size, placement, and orientation of antenna 210 is selected to focus the wireless charging magnetic field to a different area that would most likely house or contain the electronic devices to be charged. In some embodiments, antenna 210 can be a planar antenna, or an electrodeposited antenna with the antenna’s copper windings directly electrodeposited on the center console’s interior mechanical parts. The planar and electrodeposited antenna comprises a continuous conductor with no breaks or radio frequency discontinuities and can have a thickness of approximately 10 um or greater.

The internal view 200 also shows an electronic housing 220 which holds the electronics for the wireless charging system. In the representative embodiment of FIG. 2, the electronic housing 220 is disposed below a conductive structure (e.g., an iron cast portion 240) of the vehicle center console underneath the armrest 230. The placement of the electronic housing 220 is selected to minimize cross-coupling between the antenna 210 and the electronic components in the electronic housing 220. For example, the electronic housing 220 is placed physically distance from the antenna 210 or in such an area that intervening structures will shield the magnetic field of antenna 210 from coupling significantly to the electronic components.

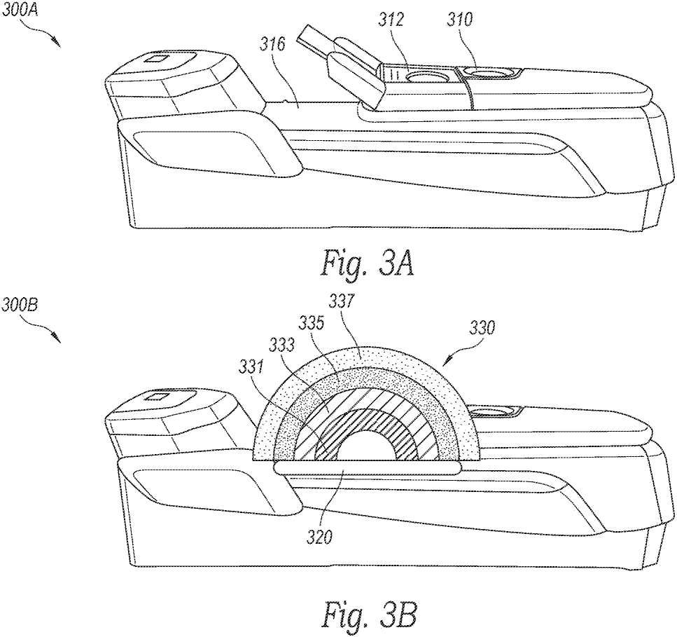

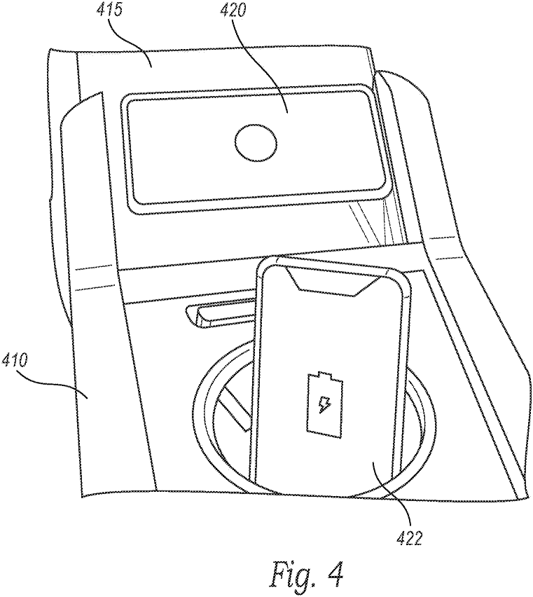

FIG. 3A is a representative view 300A of an example fully assembled vehicle center console with a wireless charging system embedded therein. For example, the antenna 210 and electronic housing 220 of FIG. 2 can be embedded within the fully assembled vehicle console of FIG. 3A. View 300A shows the fully assembled center console including a front cupholder 310, a back cupholder 312, and a package tray area 316. The antenna is configured (e.g., designed, positioned, and oriented) to transmit a wireless charging signal to efficiently charge one or more electronic devices placed in or around the front or back cupholders or the package tray area of the vehicle center console.

FIG. 3B is a representative view 300B of the fully assembled vehicle center console of FIG. 3A showing additional detail, including an outline of an embedded antenna 320 after full assembly, and an approximation of the wireless charging field 330 of the embedded antenna 320 in this example embodiment. In the wireless charging field 330, field zone 331 is depicted as having a higher signal strength than, field zone 333; field zone 333 has higher signal strength than zone 335; and, field zone 335 has higher strength than zone 337. That is, in some embodiments, the wireless charging field 330 will be such that the signal attenuates the further away you get from the embedded antenna 320. However, the length, position/placement, and orientation of the embedded antenna 320, in addition to the presence of adjacent conductive structures, affects the strength of the wireless charging field and the propagation characteristics of the charging field as illustrated in FIG. 3B. In some embodiments, the embedded antenna 320 can be a standalone antenna module such as a three-dimensional (3D) antenna, planar antenna, or an electroplated antenna. In other embodiments, the embedded antenna 320 can be an integrated antenna built into (e.g., with the parts of) the center console.

The size, shape, and position of the antenna is selected based on the packaging requirements of a specific center console design, and further based on charging area focus desired by the OEM customer. For example, in some embodiments, the length and position of the antenna can be selected such that the wireless charging field 330 is focused on the back cupholder 312 and the package tray area 316. In general, the electronics embedded in the center console are physically separated from the embedded antenna 320 (e.g., by 3 inches or greater) to reduce cross-coupling with the antenna and thereby improve the performance of the antenna. Additionally, to further improve the performance of the embedded antenna 320, it may be desirable to shape the contours of the antenna such that it not only meets the packaging requirements within the center console, but also maximizes the clearance between the antenna and the metal parts in the center console (e.g., the iron cast portion 210 in FIG. 2). The more the conductive structures such as metal are near the antenna, the more the antenna is de-Q’d or reduced in intrinsic performance. It is therefore also desirable to have the contours of the embedded antenna 320 developed so that the physical separation between the conductive parts in the center console and the antenna is maximized (e.g., separating the antenna from the conductive/metallic structures by a clearance of around 1 inch or more to improve the intrinsic quality factor of the antenna). Additionally, radio frequency (RF) shielding and absorption sheets (not shown in FIG. 3B) can be placed on or around proximate conductive structures in the center console to further improve the intrinsic ‘Q’ of the embedded antenna 320 and/or to better shape the direction of the magnetic field (e.g., as illustrated in the wireless charging field 330). The higher the antenna Q the better the wireless charging range, hence absorption sheets with a good permeability (e.g., 100 u or higher) and a good loss rate, can help improve the intrinsic ‘Q’ of the antenna (or help not to de-Q the antenna as profoundly by the presence of nearby conductive mechanical parts of the center console).

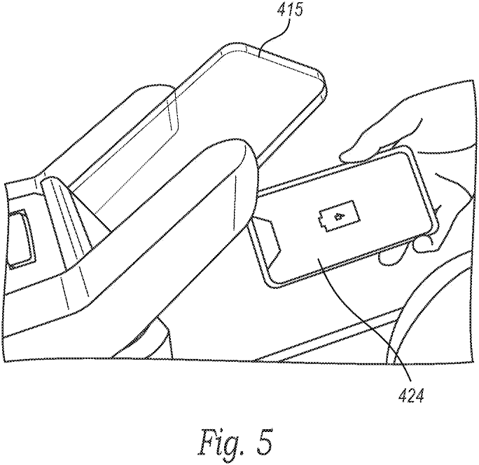

FIG. 4 is a representative illustration showing a vehicle center console 410 with a wireless charging system embedded therein simultaneously charging multiple electronic devices (e.g., electronic devices 420 and 422). The wireless charging system of FIG. 4 can be the systems described in FIGS. 2 and 3 above. As described above in relation to FIGS. 3A and 3B, the wireless charging system (e.g., the embedded antenna 320 in FIG. 3B) is positioned to provide a strong wireless charging signal to electronic devices (e.g., mobile phones, tablets, etc.) placed on or around the vehicle center console. The wireless charging system embedded in vehicle center console 410 can also be used to charge other electronic devices that include a wireless charging receiver particularly in areas of the vehicle where wiring for power delivery can be cumbersome, costly, or prevent the inclusion of new features or functionality. For example, the wireless charging system can be used to charge or power proximate electronic components of the vehicle (e.g., components around the center console) and other electronic handheld devices.

For example, FIG. 5 is a representative illustration showing the vehicle center console 410 where the embedded wireless charging system is charging a handheld electronic device 424 placed below the partition 415 without contact.

A listing of solutions that is preferably implemented by some embodiments can be described using the following clauses.

Clause 1. A wireless charging system integrated into a vehicle console, comprising: an antenna comprising a continuous conductor with no breaks or radio frequency discontinuities, wherein the continuous conductor has a thickness that is approximately equal to 10 um or greater, and wherein the antenna is disposed within or partially within one or more contours of the vehicle console; an amplifier configured to drive a signal to the antenna; and, one or more capacitors configured to excite the antenna into resonance.

Clause 2. The wireless charging system of clause 1, wherein the antenna comprises a three-dimensional antenna comprising a conductor wound around a dielectric material at an angle to diminish a proximity effect at an operating frequency of the wireless charging system thereby maintaining a high intrinsic quality factor (Q) of the three-dimensional antenna.

Clause 3. The wireless charging system of clause 1, wherein the antenna comprises a conductor electrodeposited directly onto a mechanical part of the vehicle console.

Clause 4. The wireless charging system of clause 1, wherein the signal comprises a frequency approximately equal to a resonant frequency of the antenna.

Clause 5. The wireless charging system of clause 1, further comprising a parallel resonant class E switching amplifier coupled to the antenna.

Clause 6.The wireless charging system of clause 4, further comprising one or more filters configured to receive the signal driven by the amplifier and to provide a filtered signal to the one or more capacitors.

Clause 7. The wireless charging system of clause 6, wherein two or more of the amplifier, the antenna, the one or more filters, or the one or more capacitors, are physically separated from each other by a distances at least equal to 1 inch, thereby decreasing a cross-coupling loss.

Clause 8. The wireless charging system of clause 1, wherein the antenna is disposed within the vehicle console at least 1 inch or more from one or more conductive structures in the vehicle console thereby improving an intrinsic quality factor (Q) of the antenna.

Clause 9. The wireless charging system of clause 1, wherein the antenna is configured to transmit a wireless charging signal to one or more electronic devices placed in or around at least one of a cupholder of the vehicle console or a package tray area of the vehicle console.

Clause 10. A method for fabricating a wireless charging system embedded in a vehicle console, the method comprising: attaching an amplifier printed circuit board (PCB) to a first area of an electrically non-conductive support structure of the vehicle console; attaching a filter PCB to a second area of the support structure, wherein the filter PCB is electrically coupled to the amplifier PCB and is configured to receive an amplified signal from the amplifier PCB; attaching a resonant capacitor PCB to a third area of the support structure, wherein the resonant capacitor PCB is electrically coupled to the filter PCB and to one or more antennas and is configured to receive a filtered signal from the filter PCB and drive the filtered signal onto the one or more antennas, wherein the first area, the second area, and the third area of the support structure are selected to maintain a physical separation between the amplifier PCB, the resonant capacitor PCB, the filter PCB, and the one or more antennas, and wherein a distance of the physical separation between the filter PCB and the amplifier PCB, and a distance of the physical separation between the filter PCB and the resonant capacitor PCB is at least 10 mm.

Clause 11. The method of clause 10, wherein each one of the one or more antennas comprises a three-dimensional antenna comprising a conductor wound around a dielectric material at an angle to diminish a proximity effect at an operating frequency of the wireless charging system thereby maintaining a high intrinsic quality factor (Q) of the three-dimensional antenna.

Clause 12. The method of clause 10, wherein each one of the one or more antennas comprises at least one of a planar antenna or an electrodeposited antenna comprising a conductor electrodeposited directly onto a part of the vehicle console.

Clause 13. The method of clause 10, wherein the distance of the physical separation between the filter PCB and the amplifier PCB, and the distance of the physical separation between the filter PCB and the resonant capacitor PCB is selected to decrease at least one of a cross-coupling loss, a switching loss, or a hysteresis loss.

Clause 14.The method of clause 10, further comprising: attaching a second filter PCB to a fourth area of the support structure, wherein a filter in the second filter PCB is differentially coupled to an amplifier in the amplifier PCB.

Clause 15. The method of clause 10, wherein each one of the one or more antennas are disposed within the vehicle console at least 1 inch or more from one or more conductive structures in the vehicle console thereby improving an intrinsic quality factor (Q) of the antennas.

Clause 16. The method of clause 10, wherein the each one of the one or more antennas are configured to transmit a wireless charging signal to one or more electronic devices placed in or around at least one of a cupholder of the vehicle console or a package tray area of the vehicle console.

### Remarks

The figures and above description provide a brief, general description of a suitable environment in which embodiments can be implemented. The above Detailed Description of examples of embodiments is not intended to be exhaustive or to limit the claimed invention to the precise form disclosed above. While specific examples for the embodiments are described above for illustrative purposes, various equivalent modifications are possible, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges according to practical tolerances. For example, the term “approximately” may mean that actual implementations may have a practical tolerance (e. g., 1 to 5 percent) in designs.

These and other changes can be made to the described embodiments in light of the above Detailed Description. While the above description describes certain example embodiments, and describes the best mode contemplated, no matter how detailed the above appears in text, the invention can be practiced in many ways. Details of the system can vary considerably in its specific implementation, while still being encompassed by the claimed invention disclosed herein. As noted above, terminology used when describing certain features or aspects should not be taken to imply that the terminology is being redefined herein to be restricted to any specific characteristics, features, or aspects of the invention with which that terminology is associated

1. A wireless charging system integrated into a vehicle console, comprising:
an antenna comprising a continuous conductor with no breaks or radio frequency discontinuities,
wherein the continuous conductor has a thickness that is approximately equal to 10 um or greater, and
wherein the antenna is disposed within or partially within one or more contours of the vehicle console;
an amplifier configured to drive a signal to the antenna; and,
one or more capacitors configured to excite the antenna into resonance.

2. The wireless charging system of claim 1, wherein the antenna comprises a three-dimensional antenna comprising a conductor wound around a dielectric material at an angle to diminish a proximity effect at an operating frequency of the wireless charging system thereby maintaining a high intrinsic quality factor (Q) of the three-dimensional antenna.

3. The wireless charging system of claim 1, wherein the antenna comprises a conductor electrodeposited directly onto a mechanical part of the vehicle console.

4. The wireless charging system of claim 1, wherein the signal comprises a frequency approximately equal to a resonant frequency of the antenna.

5. The wireless charging system of claim 1, further comprising a parallel resonant class E switching amplifier coupled to the antenna.

6. The wireless charging system of claim 4, further comprising one or more filters configured to receive the signal driven by the amplifier and to provide a filtered signal to the one or more capacitors.

7. The wireless charging system of claim 6, wherein two or more of the amplifier, the antenna, the one or more filters, or the one or more capacitors, are physically separated from each other by a distances at least equal to 1 inch, thereby decreasing a cross-coupling loss.

8. The wireless charging system of claim 1, wherein the antenna is disposed within the vehicle console at least 1 inch or more from one or more conductive structures in the vehicle console thereby improving an intrinsic quality factor (Q) of the antenna.

9. The wireless charging system of claim 1, wherein the antenna is configured to transmit a wireless charging signal to one or more electronic devices placed in or around at least one of a cupholder of the vehicle console or a package tray area of the vehicle console.

10. A method for fabricating a wireless charging system embedded in a vehicle console, the method comprising:
attaching an amplifier printed circuit board (PCB) to a first area of an electrically nonconductive support structure of the vehicle console;
attaching a filter PCB to a second area of the support structure, wherein the filter PCB is electrically coupled to the amplifier PCB and is configured to receive an amplified signal from the amplifier PCB;
attaching a resonant capacitor PCB to a third area of the support structure,
wherein the resonant capacitor PCB is electrically coupled to the filter PCB and to one or more antennas and is configured to receive a filtered signal from the filter PCB and drive the filtered signal onto the one or more antennas,
wherein the first area, the second area, and the third area of the support structure are selected to maintain a physical separation between the amplifier PCB, the resonant capacitor PCB, the filter PCB, and the one or more antennas, and
wherein a distance of the physical separation between the filter PCB and the amplifier PCB, and a distance of the physical separation between the filter PCB and the resonant capacitor PCB is at least 10 mm.

11. The method of claim 10, wherein each one of the one or more antennas comprises a three-dimensional antenna comprising a conductor wound around a dielectric material at an angle to diminish a proximity effect at an operating frequency of the wireless charging system thereby maintaining a high intrinsic quality factor (Q) of the three-dimensional antenna.

12. The method of claim 10, wherein each one of the one or more antennas comprises at least one of a planar antenna or an electrodeposited antenna comprising a conductor electrodeposited directly onto a part of the vehicle console.

13. The method of claim 10, wherein the distance of the physical separation between the filter PCB and the amplifier PCB, and the distance of the physical separation between the filter PCB and the resonant capacitor PCB is selected to decrease at least one of a cross-coupling loss, a switching loss, or a hysteresis loss.

14. The method of claim 10, further comprising:
attaching a second filter PCB to a fourth area of the support structure, wherein a filter in the second filter PCB is differentially coupled to an amplifier in the amplifier PCB.

15. The method of claim 10, wherein each one of the one or more antennas are disposed within the vehicle console at least 1 inch or more from one or more conductive structures in the vehicle console thereby improving an intrinsic quality factor (Q) of the one or more antennas.

16. The method of claim 10, wherein each one of the one or more antennas are configured to transmit a wireless charging signal to one or more electronic devices placed in or around at least one of a cupholder of the vehicle console or a package tray area of the vehicle console.
